(19) United States
(12) Patent Application Publication
(10) Pub. No.: US 2021/0333600 A1
(43) Pub. Date: Oct. 28, 2021

(54) DISPLAY DEVICE

(71) Applicant: Japan Display Inc., Tokyo (JP)

(72) Inventor: Junko NAGASAWA, Tokyo (JP)

(73) Assignee: Japan Display Inc., Tokyo (JP)

(21) Appl. No.: 17/305,400

(22) Filed: Jul. 7, 2021

Related U.S. Application Data
(63) Continuation of application No. PCT/JP2019/050671, filed on Dec. 24, 2019.

(30) Foreign Application Priority Data
Jan. 7, 2019 (JP) 2019-000659
May 28, 2019 (JP) 2019-099647

(51) Int. Cl. G02F 1/1339

(52) U.S. Cl. CPC G02F 1/13394; G02F 1/133305; G02F 2202/28; G02F 1/13396

(57) ABSTRACT

According to one embodiment, a display device includes flexible first and second substrates, first and second protrusions protruding from the second substrate toward the first substrate, a sealing member bonding the first substrate and the second substrate together in a peripheral region outside a display region including a pixel, a first adhesive bonding the first protrusion and the first substrate together, and a second adhesive bonding the second protrusion and the first substrate together. The second protrusion is located closer to an end of the second substrate than the first protrusion. A width of the first protrusion is greater than a width of the second protrusion.

### CROSS-REFERENCE TO RELATED APPLICATIONS

This application is a Continuation Application of PCT Application No. PCT/JP2019/050671, filed Dec. 24, 2019 and based upon and claiming the benefit of priority from Japanese Patent Applications No. 2019-000659, filed Jan. 7, 2019; and No. 2019-099647, filed May 28, 2019, the entire contents of all of which are incorporated herein by reference.

### FIELD

Embodiments described herein relate generally to a display device.

### BACKGROUND

A display device such as a liquid crystal display device, for example, comprises a pair of substrates opposed to each other. Between the pair of substrates, a protrusion protruding from one substrate toward the other substrate is disposed. An example of the protrusion is a spacer for maintaining a cell gap between the substrates in a display region. The protrusion may also be disposed in a peripheral region outside the display region for various purposes.

Generally, the tip of the protrusion such as the spacer is not bonded to the other substrate. Therefore, when an external force is applied to the display device, the tip of the protrusion may be moved from where it should be. This may cause various problems leading to degradation of display quality such as misalignment of elements arranged in these two substrates.

### BRIEF DESCRIPTION OF THE DRAWINGS

FIG. 1 is a plan view showing a schematic configuration of a liquid crystal display device according to the first embodiment.

FIG. 2 is a schematic plan view of a configuration applicable to a subpixel in the first embodiment.

FIG. 3 is a schematic cross-sectional view of a display panel along line F3-F3 of FIG. 2.

FIG. 4 is an illustration showing an example of a manufacturing process of the liquid crystal display device according to the first embodiment.

FIG. 5 is an illustration showing a manufacturing process following FIG. 4.

FIG. 6 is an illustration showing a manufacturing process following FIG. 5.

FIG. 7 is an illustration showing a manufacturing process following FIG. 6.

FIG. 8 is an illustration showing a manufacturing process following FIG. 7.

FIG. 9 is a schematic cross-sectional view of a liquid crystal display device according to the second embodiment.

FIG. 10 is a schematic cross-sectional view of a liquid crystal display device according to the third embodiment.

FIG. 11 is a cross-sectional view showing an example of a liquid crystal layer in a transparent state.

FIG. 12 is a cross-sectional view showing an example of the liquid crystal layer in a scattering state.

FIG. 13 is a cross-sectional view showing another example of the liquid crystal layer in the scattering state.

FIG. 14 is a cross-sectional view showing another example of the liquid crystal layer in the transparent state.

FIG. 15 is a schematic plan view of a display panel in the third embodiment.

FIG. 16 is a schematic cross-sectional view of the display panel along line F16-F16 in FIG. 15.

FIG. 17 is a schematic plan view of a display panel provided in a liquid crystal display device according to the fourth embodiment.

FIG. 18 is a schematic cross-sectional view of the display panel along line F18-F18 in FIG. 17.

FIG. 19 is a schematic cross-sectional view of a liquid crystal display device according to the fifth embodiment.

FIG. 20 is a schematic plan view showing an example of the shapes of a light-shielding layer, a color filter and a plurality of spacers.

FIG. 21 is an illustration showing an example of a manufacturing process of the liquid crystal display device according to the fifth embodiment.

FIG. 22 is an illustration showing a manufacturing process following FIG. 21.

FIG. 23 is an illustration showing a manufacturing process following FIG. 22.

FIG. 24 is an illustration showing a manufacturing process following FIG. 23.

FIG. 25 is an illustration showing a manufacturing process following FIG. 24.

FIG. 26 is a graph showing an example of the relationship between a load applied to the spacer and a deformation amount of the spacer.

FIG. 27 is a schematic cross-sectional view of a liquid crystal display device according to the sixth embodiment.

FIG. 28 is an illustration showing an example of a manufacturing process of the liquid crystal display device according to the sixth embodiment.

FIG. 29 is an illustration showing a manufacturing process following FIG. 28.

FIG. 30 is an illustration showing a manufacturing process following FIG. 29.

### DETAILED DESCRIPTION

In general, according to one embodiment, there is provided a display device comprising a first substrate having flexibility, a second substrate having flexibility and opposed to the first substrate, a sealing member bonding the first substrate and the second substrate together in a peripheral region outside a display region including a pixel, a first protrusion and a second protrusion protruding from the second substrate toward the first substrate, a first adhesive bonding the first protrusion and the first substrate together, and a second adhesive bonding the second protrusion and the first substrate together. The second protrusion is located closer to an end of the second substrate than the first protrusion, and a width of the first protrusion is greater than a width of the second protrusion.

According to another embodiment, there is provided a display device comprising a first substrate, a second substrate opposed to the first substrate, a sealing member bonding the first substrate and the second substrate together in a peripheral region outside a display region including a pixel, a protrusion protruding from the second substrate toward the first substrate, and an adhesive bonding the protrusion and the first substrate together. The protrusion extends along the sealing member in the peripheral region.

According to yet another embodiment, there is provided a display device comprising a first substrate, a second substrate opposed to the first substrate, a sealing member bonding the first substrate and the second substrate together in a peripheral region outside a display region including a pixel, and a first protrusion and a second protrusion protruding from the second substrate toward the first substrate. The first protrusion is in contact with the first substrate without being bonded to the first substrate, and the second protrusion is bonded to the first substrate.

According to yet another embodiment, there is provided a display device comprising a first substrate, a second substrate opposed to the first substrate, a sealing member bonding the first substrate and the second substrate together in a peripheral region outside a display region including a pixel, a first protrusion and a second protrusion protruding from the second substrate toward the first substrate, and an adhesive bonding the first protrusion and the first substrate together. The second protrusion and the first substrate are opposed to each other via a gap.

According to each of the above configurations, a display device improved in the structure of a protrusion arranged between a pair of substrates and having excellent display quality can be provided.

Embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings are illustrated schematically rather than as an accurate representation of what is implemented. However, such schematic illustration is merely exemplary, and in no way restricts the interpretation of the invention. In the drawings, the reference numbers of the same or similar elements which are arranged consecutively may be omitted. In addition, in the specification and drawings, constituent elements which function in the same or a similar manner to those described in connection with preceding drawings may be denoted by the same reference numbers, and detailed descriptions which are considered redundant may be omitted.

In each embodiment, a liquid crystal display device is disclosed as an example of the display device. Each embodiment does not preclude application of individual technical ideas disclosed in each embodiment to other types of display device. The other types of display device are assumed to be, for example, a self-luminous display device having an organic electroluminescent display element or light-emitting diode (LED) display element, an electronic paper display deice having an electrophoretic element, a display device employing micro-electromechanical systems (MEMS), a display device employing electrochromism and the like.

### First Embodiment

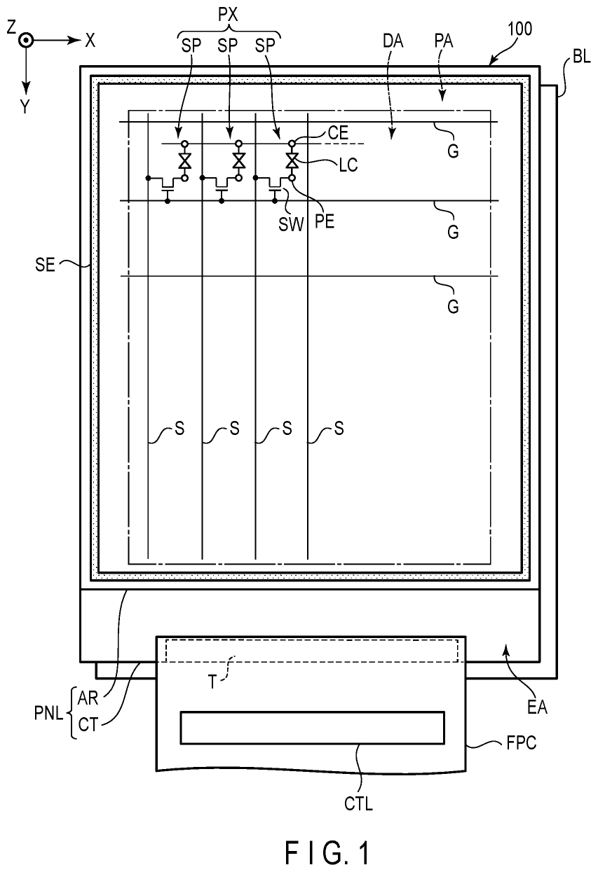

FIG. 1 is a plan view showing a schematic configuration of a liquid crystal display device 100 (hereinafter referred to as a display device 100) according to the first embodiment. In the drawing, a first direction X, a second direction Y and a third direction Z are directions orthogonal to one another. In the present embodiment, the first direction X, the second direction Y and the third direction Z are orthogonal to one another. However, these directions may intersect at an angle other than 90 degrees.

The display device 100 comprises a display panel PNL, a backlight BL, a flexible circuit board FPC and a controller CTL. The display panel PNL comprises an array substrate AR, a counter substrate CT opposed to the array substrate AR, a sealing member SE and a liquid crystal layer LC. The array substrate AR and the counter substrate CT are an example of the first substrate and the second substrate. The sealing member SE bonds the array substrate AR and the counter substrate CT together. The liquid crystal layer LC is sealed in a region surrounded by the array substrate AR, the counter substrate CT and the sealing member SE.

In the example of FIG. 1, the array substrate AR has an extension region EA which extends more than the lower end in the drawing of the counter substrate CT. The extension region EA includes a terminal T for external connection. The flexible circuit board FPC is connected to the terminal T. In the example of FIG. 1, the array substrate AR and the counter substrate CT have a rectangular shape. However, these substrates may have another shape.

The display panel PNL has a display region DA for displaying an image, and a peripheral region PA outside the display region DA. The peripheral region PA includes the extension region EA. In the display region DA, the array substrate AR comprises a plurality of scanning lines G and a plurality of signal lines S. The scanning lines G each extend in the first direction X, and are arranged in the second direction Y. The signal lines S each extend in the second direction Y, and are arranged in the first direction X.

The display region DA has a plurality of pixels PX arranged in a matrix. The pixels PX each include a plurality of subpixels SP corresponding to different colors. In one example, the pixel PX includes red, green and blue subpixels SP. However, the pixel PX may include a subpixel of another color such as white. The array substrate AR comprises a pixel electrode PE and a switching element SW which are arranged in each subpixel SP. The array substrate AR further comprises a common electrode CE extending over the subpixels SP. A common voltage is applied to the common electrode CE.

The controller CTL supplies a signal necessary for driving for image display to the display panel PNL. In the example of FIG. 1, the controller CTL may be mounted on the flexible circuit board FPC. However, the controller CTL may be mounted on another member.

The blacklight BL is opposed to the back surface of the array substrate AR. For example, the blacklight BL may be an edge light type comprising a light guide and a light source opposed to an end of the light guide, or may be a direct type comprising a light source opposed to the back surface of the array substrate AR. In addition, the display device 100 may be a reflective type which does not comprise the backlight BL.

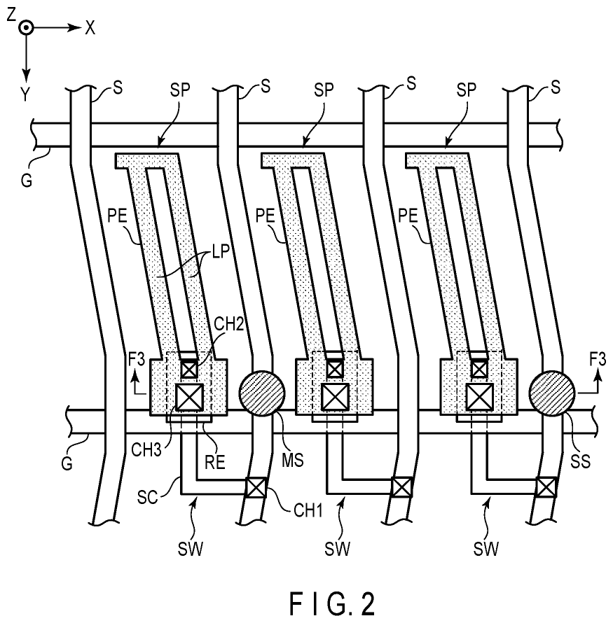

FIG. 2 is a schematic plan view of a structure applicable to the subpixel SP. In this example, the pixel electrode PE has a shape having two line portions LP. The pixel electrode PE may have more line portions LP or may have only one line portion LP. The pixel electrode PE and the above-described common electrode CE can be formed of, for example, a transparent conductive material such as indium tin oxide (ITO).

The line portions LP are inclined with respect to the second direction Y. The signal line S is inclined in the same manner as the line portions LP. In the subpixel SP which is adjacent in the second direction Y to the illustrated subpixel SP, the shapes of the pixel electrode PE and the signal line S are line symmetric in the second direction Y with respect to the shapes of those in the illustrated subpixel SP. Accordingly, a pseudo multi-domain pixel layout can be realized. However, the pixel layout is not limited to this example, but may be a structure for realizing multiple domains in one subpixel SP or may be a single domain structure.

The switching element SW comprises a semiconductor layer SC and a relay electrode RE. The semiconductor layer SC is connected to the signal line S through a contact hole CH1, and is connected to the relay electrode RE through a contact hole CH2. The semiconductor layer SC intersects the scanning line G once between the contact holes CH1 and CH2, but may intersect the scanning line G twice. The relay electrode RE is connected to the pixel electrode PE through a contact hole CH3.

In the display region DA, a plurality of main spacers MS and a plurality of subspacers SS are arranged. The main spacer MS is an example of the first protrusion, and the subspacer SS is an example of the second protrusion.

In the example of FIG. 2, the main spacer MS and the subspacer SS are arranged across two subpixels SP. However, these spacers are not limited to this example. The main spacer MS and the subspacer SS can be arranged at various densities. The number of main spacers MS and the number of subspacers SS arranged in the display region DA may be the same or may be different from each other.

The main spacer MS and the subspacer SS each are arranged close to the intersection of the scanning line G and the signal line S. In the example of FIG. 2, the contact hole CH3 of each subpixel SP and the spacers MS and SS are arranged in the first direction X.

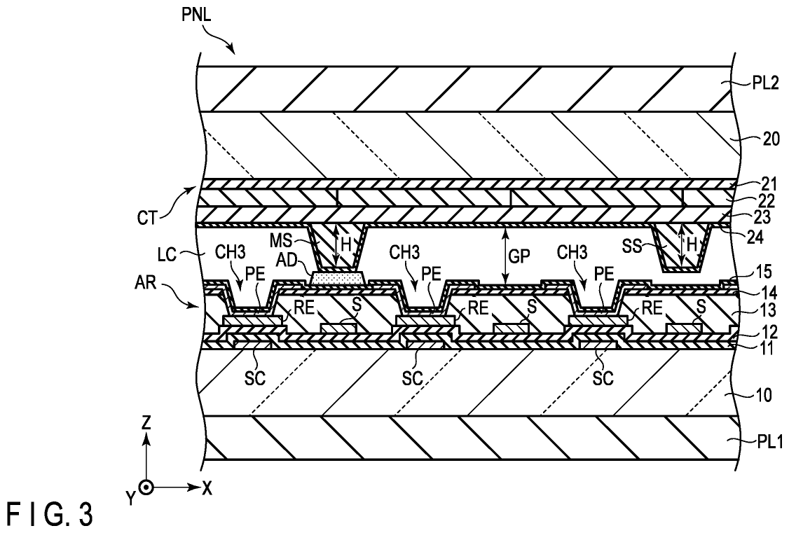

FIG. 3 is a schematic cross-sectional view of the display panel PNL along line F3-F3 in FIG. 2. The array substrate AR comprises a first base 10, a first insulating layer 11, a second insulating layer 12, a third insulating layer 13, a fourth insulating layer 14 and a first alignment film 15. The insulating layers 11 to 14 are stacked in the third direction Z.

The semiconductor layer SC is arranged between the first base 10 and the first insulating layer 11. Another insulating layer may be interposed between the semiconductor layer SC and the first base 10. Although not shown in the cross section of FIG. 3, the scanning line G is arranged between the first insulating layer 11 and the second insulating layer 12. The signal line S and the relay electrode RE are arranged between the second insulating layer 12 and the third insulating layer 13. Although not shown in the cross section of FIG. 3, the common electrode CE is arranged between the third insulating layer 13 and the fourth insulating layer 14.

The pixel electrode PE is arranged on the fourth insulating layer 14. The first alignment film 15 covers the pixel electrode PE and the fourth insulating layer 14. The third insulating layer 13 is formed of, for example, an organic resin material, and is thicker than the other insulating layers 11, 12 and 14.

The above-described contact hole CH3 is provided in the third insulating layer 13, and the pixel electrode PE is connected to the relay electrode RE through this contact hole CH3. Although not shown in the cross section of FIG. 3, the above-described contact holes CH1 and CH2 both penetrate the first insulating layer 11 and the second insulating layer 12.

The counter substrate CT comprises a second base 20, a light-shielding layer 21, a color filter layer 22, an overcoat layer 23 and a second alignment film 24. The light-shielding layer 21 is formed on the lower surface of the second base 20, and is opposed to the scanning line G, the signal line S and the relay electrode RE. In the cross section of FIG. 3, the light-shielding layer 21 is disposed entirely. However, the light-shielding layer 21 is open in the subpixel SP.

The color filter layer 22 covers the light-shielding layer 21. The color filter layer 22 includes a plurality of color filters corresponding to the colors of the subpixels SP. The overcoat layer 23 covers the color filter layer 22. The second alignment film 24 covers the overcoat layer 23.

A first polarizer PL1 is arranged on the lower surface of the first base 10. A second polarizer PL2 is arranged on the upper surface of the second base 20. The liquid crystal layer LC is arranged between the first alignment film 15 and the second alignment film 24.

The first base 10 and the second base 20 can be formed of, for example, glass. In addition, the first base 10 and the second base 20 can be formed of a resin material such as polyimide. In this case, the array substrate AR and the counter substrate CT having flexibility can be obtained, and therefore the display panel PNL can be bent.

The main spacer MS and the subspacer SS protrude from the counter substrate CT toward the array substrate AR. In the example of FIG. 3, the main spacer MS and the subspacer SS are covered with the second alignment film 24. However, at least a part of the main spacer MS and the subspacer SS may not be covered with the second alignment film 24.

For example, the main spacer MS and the subspacer SS have a circular planar shape as shown in FIG. 2, and have a trapezoidal cross-sectional shape as shown in FIG. 3. However, the planar shape and the cross-sectional shape of the main spacer MS and the subspacer SS are not limited to these examples. As another example, the main spacer MS and the subspacer SS may have a long planar shape in a predetermined direction.

In the present embodiment, the main spacer MS and the subspacer SS have a same height H. The height H is less than a cell gap GP between the array substrate AR and the counter substrate CT. The height of the main spacer MS and the height of the subspacer SS may be different from each other.

An adhesive AD is arranged between the main spacer MS and the array substrate AR. The adhesive AD is arranged on the first alignment film 15 between two contact holes CH3 arranged in the first direction X. The adhesive AD bonds the tip of the main spacer MS and the array substrate AR together. The height of the adhesive AD is less than the height H of the main spacer MS, for example.

In the example of FIG. 3, the width of the adhesive AD is slightly greater than the width of the tip of the main spacer MS. However, the width of the adhesive AD may be the same as the width of the tip of the main spacer MS or may be less than the width of the tip.

On the other hand, no adhesive is arranged but a gap is formed between the subspacer SS and the array substrate AR. Therefore, the subspacer SS and the array substrate AR are opposed to each other via the liquid crystal layer LC which is present in the gap.

The main spacer MS maintains the cell gap between the array substrate AR and the counter substrate CT constant. The subspacer SS contacts the array AR, for example, when an external force is applied to the display panel PNL, and suppresses excess deformation of the cell gap.

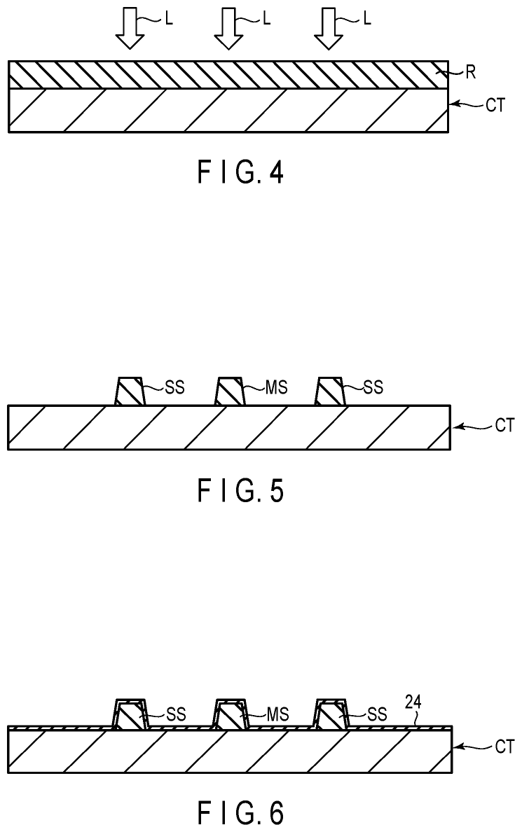

Next, an example of the manufacturing method of the display device 100 will be described with reference to FIGS. 4 to 8. First, the array substrate AR comprising the first base 10, the insulating layers 11 to 14, the first alignment film 15, the scanning line G, the signal line S, the switching element SW, the pixel electrode PE and the common electrode CE is manufactured. In addition, the counter substrate CT comprising the second base 20, the light-shielding layer 21, the color filter layer 22 and the overcoat layer 23 is manufactured.

Then, as shown in FIG. 4, a photoresist R which becomes the base of the main spacer MS and the subspacer SS is formed on the counter substrate CT (on the overcoat layer 23). Furthermore, the photoresist R is baked (pre-baking), and then light L is radiated to positions at which the main spacer MS and the subspacer SS are formed in the photoresist R (exposure).

After that, the excess photoresist R is removed using a chemical solution (development) so that the main spacer MS and the subspacer SS are formed as shown in FIG. 5. As an example, one main spacer MS and two subspacers SS are illustrated here. The main spacer MS and the subspacer SS are further baked so that strength thereof can be increased (post-baking).

After the main spacer MS and the subspacer SS are formed, the second alignment film 24 is formed as shown in FIG. 6. The main spacer MS and the subspacer SS are covered with the second alignment film 24. Since the uncured second alignment film 24 has fluidity, the second alignment film 24 may flow down from the tips of the main spacer MS and the subspacer SS. In this case, the tips of the main spacer MS and the subspacer SS are exposed from the second alignment film 24 or covered with the thinner second alignment film 24 than other parts thereof.

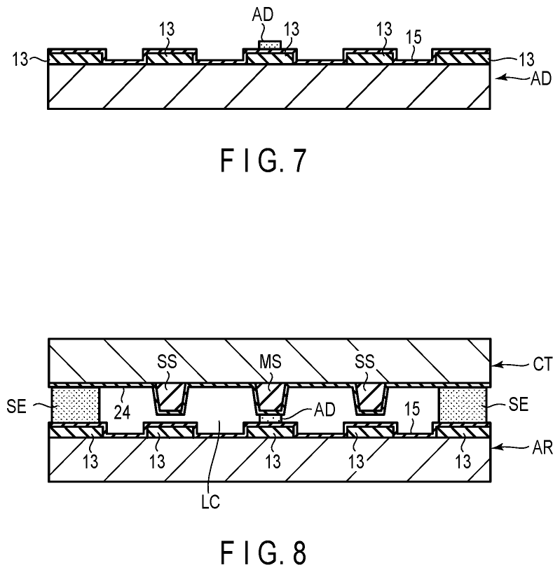

As shown in FIG. 7, in the array substrate AR, the adhesive AD is formed by, for example, an ink-jet method at a position corresponding to the main spacer MS. For example, acrylic resin can be used as the adhesive AD. However, the adhesive AD is not limited to this example.

The counter substrate CT and the array substrate AR manufactured in this way are bonded together by the sealing member SE as shown in FIG. 8. The tip of the main spacer MS contacts the adhesive AD either directly or via the second alignment film 24.

The liquid crystal layer LC can be formed by, for example, a dropping method (ODF method). That is, the frame-shaped sealing member SE is formed on one of the array substrate AR and the counter substrate CT, a liquid crystal material is dropped inside the sealing member SE, and these two substrates are bonded together in a vacuum atmosphere. It should be noted that the liquid crystal layer LC can also be formed by a vacuum injection method. In that case, an injection port is provided in the sealing member SE, and the liquid crystal material is injected through the injection port after these two substrates are bonded together.

The sealing member SE is, for example, a UV curable material, and is cured by UV light irradiation. After the curing by UV light, heat is applied so that the curing of the sealing member SE further progress. At this time, the adhesive AD is also thermally cured. In order to promote the thermal curing of the adhesive AD, a thermal curing agent may be contained in the adhesive AD. For example, an imidazole-based thermal curing agent, an amine-based thermal curing agent, a phenol-based thermal curing agent, a polythiol-based thermal curing agent, an acid anhydride, a thermal cation initiator or the like can be used as the thermal curing agent. One type of thermal curing agent may be used, or two or more types of thermal curing agent may be used in combination.

Low-temperature curing resin may be used as the adhesive AD so that the cross-linking of the adhesive AD progresses even at the thermal curing temperature of the sealing member SE which is a relatively low temperature. In this case, since it is not necessary to apply high temperature, it is possible to obtain an effect of preventing the peeling of the main spacer MS due to the thermal expansion difference between the counter substrate CT and the array substrate AR.

If the main spacer MS is not bonded to the array substrate AR by the adhesive AD, the array substrate AR and the counter substrate CT are bonded together only by the sealing member SE in the peripheral region PA. In that case, in the display region DA, an element such as the pixel electrode PE of the array substrate AR and an element such as the color filter layer 22 of the counter substrate CT are likely to be misaligned with each other. When such a misalignment occurs, color mixing may occur, that is, light to be transmitted through the color filter layer 22 of a certain subpixel SP may be transmitted through that of an adjacent subpixel SP. Furthermore, the tip of the main spacer MS may damage the first alignment film 15, and an undesired alignment ability may be imparted to the first alignment film 15. Accordingly, the display quality of the display device 100 may be degraded.

On the other hand, when the main spacer MS is bonded to the array substrate AR by the adhesive AD as in the present embodiment, the array substrate AR and the counter substrate CT are unlikely to be misaligned with each other in the display region DA. In addition, the tip of the main spacer MS does not damage the first alignment film 15.

Furthermore, when the main spacer MS and the subspacer SS have the same height H, the manufacturing process of the main spacer MS and the subspacer SS becomes easy. That is, if the main spacer MS and the subspacer SS have different heights, multi-tone exposure is required in the process shown in FIG. 4. On the other hand, when the main spacer MS and the subspacer SS have the same height H, multi-tone exposure is not required.

The present embodiment illustrates a configuration where the main spacer MS and the subspacer SS, which are an example of the first protrusion and the second protrusion, protrude from the counter substrate CT toward the array substrate AR. However, the main spacer MS and the subspacer SS may protrude from the array substrate AR toward the counter substrate CT.

### Second Embodiment

The second embodiment will be described. Configurations and effects which are not particularly mentioned are the same as those of the first embodiment.

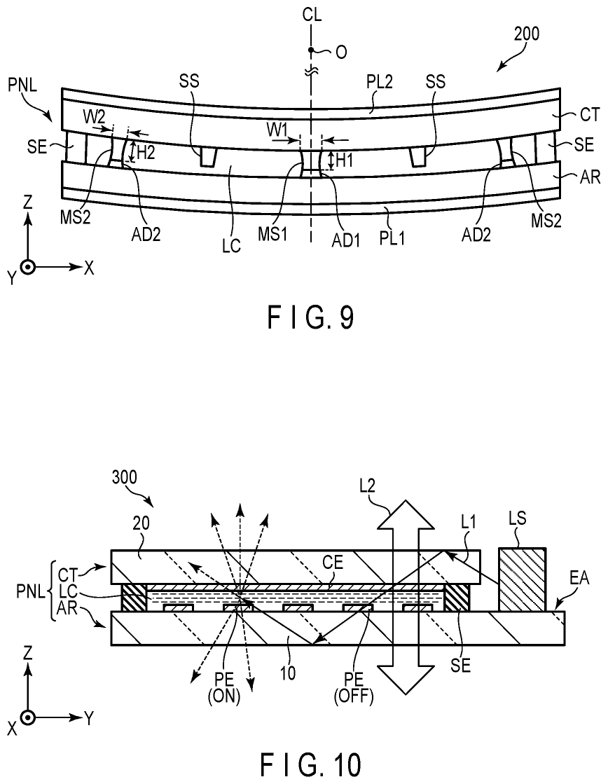

FIG. 9 is a schematic cross-sectional view of a liquid crystal display device 200 (hereinafter referred to as a display device 200) according to the second embodiment. In the illustrated example, the display panel PNL is bent. These array substrate AR and counter substrate CT having flexibility can be realized by forming the first base 10 and the second base 20 using a resin material as described above.

In the example of FIG. 9, the array substrate AR and the counter substrate CT are bent entirely such that the array substrate AR side becomes convex. That is, a center of curvature O of these bent array substrate AR and counter substrate CT is located on the counter substrate CT side. As another example, the display panel PNL may be bent such that the counter substrate CT side becomes convex. In addition, the display panel PNL may include a bent part and a flat part.

A first main spacer MS1 is arranged close to a center CL in the first direction X of the display panel PNL, and a second main spacer MS2 is arranged at a position closer to the end of the counter substrate CT than the first main spacer MS1. Although one first main spacer MS1 and two second main spacers MS are shown in FIG. 9, the display panel PNL comprises more main spacers MS1 and MS2. In addition, the display panel PNL may comprise a plurality of subspacers SS as in the first embodiment.

The width of the first main spacer MS1 is W1, and the height of the first main spacer MS1 is H1. The first main spacer MS1 is bonded to the array substrate AR by a first adhesive AD1. The first main spacer MS1 is an example of the first protrusion in the present embodiment.

The width of the second main spacer MS2 is W2, and the height of the second main spacer MS2 is H2. The second main spacer MS2 is bonded to the array substrate AR by a second adhesive AD2. The second main spacer MS2 is an example of the second protrusion in the present embodiment.

Close to the center CL, a large force due to bending is applied in the thickness direction. Therefore, it is preferable to increase the width W1 (or the cross-sectional area) of the first main spacer MS1. Accordingly, a stress applied to the first main spacer MS1 is reduced, and the buckling of the first main spacer MS1 can be suppressed.

On the other hand, close to the end of the display panel PNL, a large force due to bending is applied in a direction parallel to the planes of the array substrate AR and the counter substrate CT. Therefore, it is preferable to increase the height H2 of the second main spacer MS2. Accordingly, the followability of the second main spacer MS2 to the misalignment of the array substrate AR and the counter substrate CT increases, and the peeling of the second main spacer MS2 and the array substrate AR can be suppressed.

From the above, in the present embodiment, the shapes of the main spacers MS1 and MS2 are set such that W1>W2 and H1<H2 are satisfied. The widths W1 and W2 may be the width of the root of the main spacers MS1 and MS2, the width of the tip, or the width of the middle between the root and the tip. It is preferable that W1>W2 should be satisfied at each of the root, the tip and the middle. The shape of the subspacer SS is not particularly limited, but as an example, the width of the subspacer SS may be set to W2 and the height of the subspacer SS may be set to H1.

By contriving the shapes of the main spacers MS1 and MS2 ingeniously as in the present embodiment, even when the display panel PNL is bent, the misalignment of the array substrate AR and the counter substrate CT and the change of the cell gap are suppressed, and consequently, display quality can be improved.

Although two main spacers MS1 and MS2 are illustrated in the present embodiment, the display panel PNL may comprise three or more types of main spacer MS having different widths and heights. In that case, for example, the width may be increased as the main spacer MS is closer to the center CL, and the height may be increased as the main spacer MS is closer to the end of the display panel PNL.

### Third Embodiment

The third embodiment will be described. In the present embodiment, a transparent liquid crystal display device through which a background can be visually recognized will be described. Configurations and effects which are not particularly mentioned are the same as those of the first embodiment.

FIG. 10 is a schematic cross-sectional view of a liquid crystal display device 300 (hereinafter referred to as a display device 300) according to the third embodiment. The display device 300 comprises the display panel PNL and a light source LS. The display panel PNL comprises the array substrate AR, the counter substrate CT, the liquid crystal layer LC and the sealing member SE.

The array substrate AR comprises the first base 10 and the pixel electrode PE. The counter substrate CT comprises the second base 20 and the common electrode CE. The first base 10 and the second base 20 each are formed of, for example, glass. However, the first base 10 and the second base 20 can also be formed of a transparent resin material. The pixel electrode PE and the common electrode CE can be formed of a transparent conductive material such as indium tin oxide (ITO). In the present embodiment, the counter substrate CT comprises no color filter layer.

The light source LS is arranged in the extension region EA, and radiates light to a side surface of the counter substrate CT. The light source LS may be arranged at a position other than the extension region EA. Furthermore, the light source LS may radiate light to a side surface of the array substrate AR.

For example, the light source LS includes an LED which emits red light, an LED which emits green light, and an LED which emits blue light. However, the light source LS may comprise an LED which emit light other than red, green and blue light. A lens system may be arranged between the light source LS and the counter substrate CT.

The liquid crystal layer LC in the present embodiment is configured to be switchable between a scattering state of scattering light and a transparent state of transmitting light almost without scattering light according to applied voltage. For example, the liquid crystal layer LC close to the pixel electrode PE (OFF in the drawing) to which voltage is not applied is in the transparent state, and the liquid crystal layer LC close to the pixel electrode PE (ON in the drawing) to which voltage is applied is in the scattering state. On the contrary to this, the liquid crystal layer LC close to the pixel electrode PE to which voltage is not applied may be in the scattering state, and the liquid crystal layer LC close to the pixel electrode PE to which voltage is applied may be in the transparent state.

Light L1 emitted by the light source LS is made incident on the side surface of the counter substrate CT, and propagates inside the counter substrate CT and the array substrate AR. The light L1 is scattered in the liquid crystal layer LC in the scattering state. This scattered light is emerged from the array substrate AR and the counter substrate CT, and can be visually recognized as a display image from both the array substrate AR side and the counter substrate CT side.

External light L2 entering the liquid crystal layer LC in the transparent state is transmitted through the display device 1 almost without being scattered. That is, the background on the array substrate AR side can be visually recognized when the display device 300 is viewed from the counter substrate CT side, and the background on the counter substrate CT side can be visually recognized when the display device 300 is viewed from the array substrate AR side.

The display device 300 configured as described above can be driven by, for example, a field sequential method. In this method, one frame period includes a plurality of subframe periods (fields). For example, when the light source LS includes red, green and blue LEDs, one frame period includes red, green and blue subframe periods.

In the red subframe period, the red LED is turned on, and a voltage corresponding to red image data is applied to each pixel electrode PE. Accordingly, a red image is displayed. Similarly, in the green subframe period and the blue subframe period, the green LED and the blue LED are turned on, respectively, and a voltage corresponding to green image data and a voltage correspond to blue image data are applied to each pixel electrode PE, respectively. Accordingly, a green image and a blue image are displayed, respectively. The red, green and blue images displayed in a time-division manner as described above are combined and visually recognized as a multicolor display image by an observer.

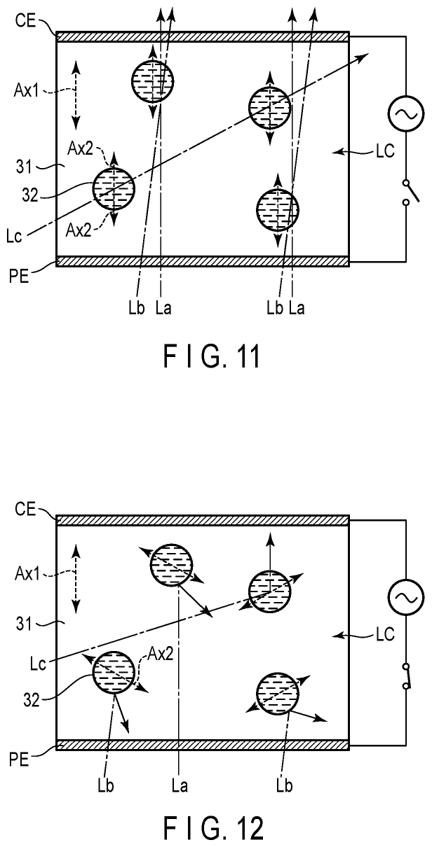

FIGS. 11 and 12 each are a cross-sectional view showing an example of a configuration applicable to the liquid crystal layer LC. The liquid crystal layer LC contains a liquid crystal polymer 31 and liquid crystal molecules 32 which are an example of a polymer liquid crystal composition. The liquid crystal polymer 31 and the liquid crystal molecule 32 have equal optical anisotropy or refractive index anisotropy. In addition, the liquid crystal polymer 31 and the liquid crystal molecule 32 have different responsivenesses to an electric field. That is, the responsiveness to an electric field of the liquid crystal polymer 31 is lower than the responsiveness to an electric field of the liquid crystal molecule 32.

The example shown in FIG. 11 corresponds to, for example, the transparent state where voltage is not applied to the liquid crystal layer LC (a state where the potential difference between the pixel electrode PE and the common electrode CE is zero). In this state, an optical axis Ax1 of the liquid crystal polymer 31 and an optical axis Ax2 of the liquid crystal molecule 32 are parallel to each other.

As described above, the liquid crystal polymer 31 and the liquid crystal molecule 32 have substantially equal refractive index anisotropy, and the optical axes Ax1 and Ax2 are parallel to each other. Therefore, there is almost no refractive index difference between the liquid crystal polymer 31 and the liquid crystal molecule 32 in all directions. Accordingly, a ray of light La parallel to the thickness direction (the third direction Z) of the liquid crystal layer LC and rays of light Lb and Lc inclined with respect to this thickness direction are transmitted through the liquid crystal layer LC almost without being scattered.

The example shown in FIG. 12 corresponds to the scattering state where voltage is applied to the liquid crystal layer LC (a state where a potential difference is formed between the pixel electrode PE and the common electrode CE). As described above, the responsiveness to an electric field of the liquid crystal polymer 31 is lower than the responsiveness to an electric field of the liquid crystal molecule 32. Therefore, while the alignment direction of the liquid crystal polymer 31 hardly changes, the alignment direction of the liquid crystal molecule 32 changes according to an electric field, and consequently, the optical axis Ax2 becomes inclined with respect to the optical axis Ax1. Accordingly, a large refractive index difference is generated between the liquid crystal polymer 31 and the liquid crystal molecule 32 in all directions. In this state, the rays of light La, Lb and Lc entering the liquid crystal layer LC are scattered in the liquid crystal layer LC.

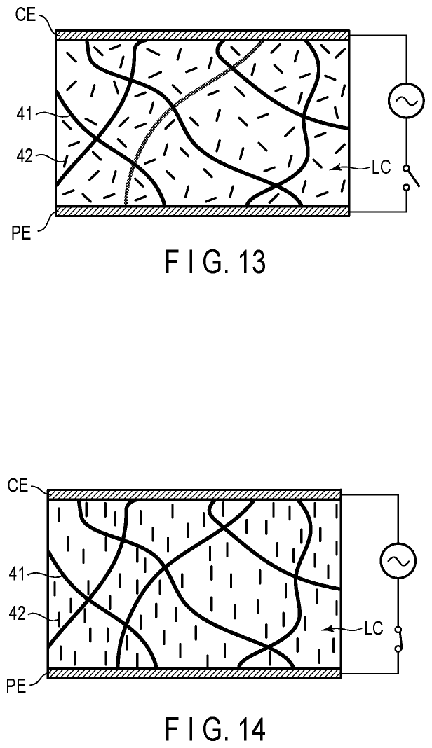

FIGS. 13 and 14 each are a cross-sectional view showing another example of the configuration applicable to the liquid crystal layer LC. The configuration shown in FIGS. 13 and 14 corresponds to a polymer network liquid crystal in which a polymer fiber structure (polymer network structure) is formed in the liquid crystal layer LC. That is, the liquid crystal layer LC has network-like polymers 41 and liquid crystal molecules 42. The polymers 41 are arranged irregularly in FIGS. 13 and 14, but the polymers 41 may be arranged substantially parallel to the main surface of the array substrate AR (see FIG. 10).

FIG. 13 shows a scattering state where voltage is not applied to the liquid crystal layer LC, and the liquid crystal molecules 42 are arranged irregularly by the effect of the polymers 41. In this state, light entering the liquid crystal layer LC is scattered. FIG. 14 shows s transparent state where voltage is applied to the liquid crystal layer LC, and the liquid crystal molecules 42 are aligned in a predetermined direction. In this state, light is transmitted through the liquid crystal layer LC almost without being scattered.

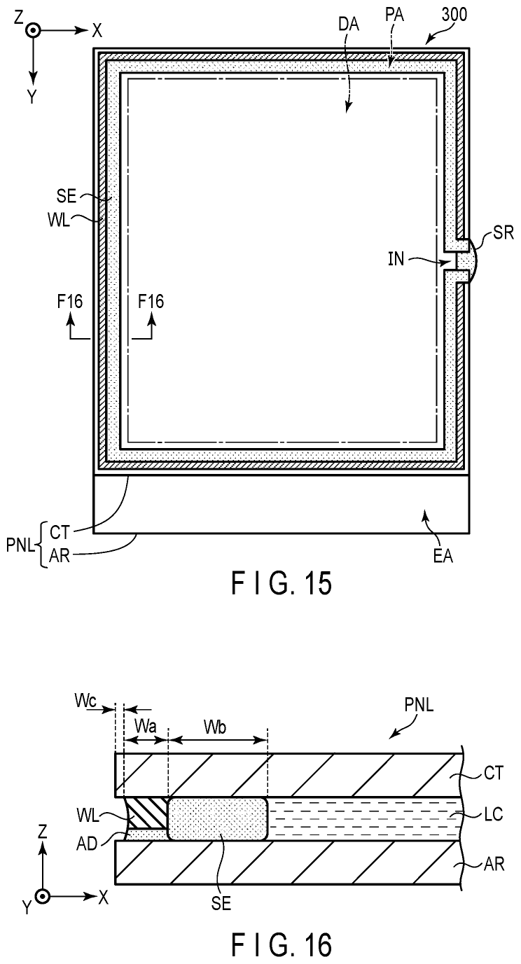

FIG. 15 is a schematic plan view of the display panel PNL. In the present embodiment, the liquid crystal layer LC is formed by injecting the liquid crystal material between the array substrate AR and the counter substrate CT by the ODF method. The sealing member SE has an injection port IN for injecting the liquid crystal material in the manufacturing process of the display panel PNL. The injection port IN is closed by a sealing resin SR.

In the peripheral region PA, a wall portion WL is arranged between the array substrate AR and the counter substrate CT. In the example of FIG. 15, the wall portion WL is located between the peripheral edge of the counter substrate CT and the sealing member SE, and extends in a frame shape along the sealing member SE. The wall portion WL surrounds the sealing member SE except the injection port IN.

The wall portion WL is an example of the protrusion in the present embodiment. The display panel PNL may further comprise the main spacer MS and the subspacer SS disclosed in the first embodiment and the second embodiment.

FIG. 16 is a schematic cross-sectional view of the display panel PNL along line F16-F16 in FIG. 15. The wall portion WL protrudes from the counter substrate CT toward the array substrate AR. The adhesive AD is arranged between the tip of the wall portion WL and the array substrate AR. The wall portion WL and the adhesive AR can be formed by, for example, the same process as the main spacer MS and the adhesive AD in the first embodiment.

When a width Wa of the wall portion WL is large, the peripheral region PA increases. Therefore, it is preferable that the width Wa should be less than a width Wb of the sealing member SE (Wa<Wb). The width Wa may be the width of the root of the wall portion WL, the width of the tip, or the width of the middle between the root and the tip. It is preferable that Wa<Wb should be satisfied at each of the root, the tip and the middle. When the width Wa is less than or equal to half the width Wb, the increase of the peripheral region PA can be more preferably suppressed. More specifically, it is preferable that the width Wb should be set to greater than or equal to 100 μm and the width Wa should be set to a range of greater than or equal to 5 μm but less than or equal to 10 μm.

The wall portion WL and the adhesive AD are in contact with the sealing member SE. In planar view, a gap is provided between the side surface of the counter substrate CT and the wall portion WL. By providing this gap, it is possible to suppress the wall portion WL and the adhesive AD from inhibiting cutting when the display panel PNL is cut from a mother glass in the manufacturing process of the display device 300. For example, a width We of the gap is less than the width Wa (Wc<Na).

When the liquid crystal material is injected from the injection port IN in the manufacturing process of the display device 300, the liquid crystal material may flow over the injection port IN, and may enter the gap between the array substrate AR and the counter substrate CT outside the sealing member SE. The liquid crystal material may reach not only the side having the injection port IN but also the other sides through this gap. Particularly when the liquid crystal material outside the sealing member SE enters between the light source LS and the counter substrate CT, it absorbs or reflects light from the light source LS, and causes reduction of light use efficiency. When light use efficiency is reduced, image brightness is reduced, and display quality may be degraded accordingly.

In the present embodiment, the wall portion WL is disposed between the sealing member SE and the peripheral edge of the counter substrate CT. Therefore, the entry of the liquid crystal material to the gap between the array substrate AR and the counter substrate CT outside the sealing member SE can be suppressed.

Furthermore, since the wall portion WL is bonded to the array substrate AR by the adhesive AD, the gap between the array substrate AR and the counter substrate CT can be closed more preferably. As a result, the effect of suppressing the entry of the liquid crystal material is enhanced.

The present embodiment illustrates a configuration where the wall portion WL which is an example of the protrusion protrudes from the counter substrate CT toward the array substrate AR. However, the wall portion WL may protrude from the array substrate AR toward the counter substrate CT.

### Fourth Embodiment

The fourth embodiment will be described. In the present embodiment, a transparent liquid crystal display device is described as in the third embodiment. Configurations and effects which are not particularly mentioned are the same as those of the third embodiment.

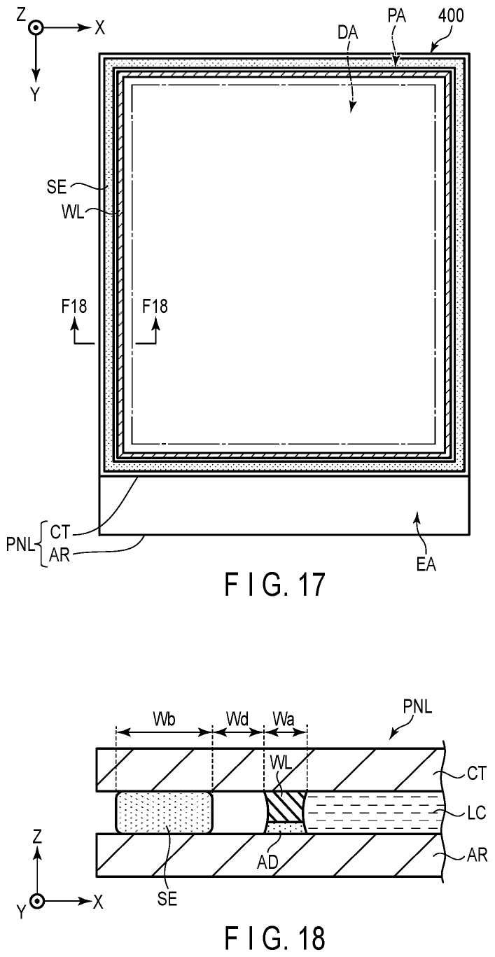

FIG. 17 is a schematic plan view of the display panel PNL provided in a liquid crystal display device 400 (hereinafter referred to as a display device 400) according to the fourth embodiment. In the present embodiment, the sealing member SE has no injection port for the liquid crystal material. In this configuration, the liquid crystal layer LC can be formed by the ODF method.

In the present embodiment, the wall portion WL is arranged between the sealing member SE and the display region DA. The wall portion WL has, for example, a frame shape surrounding the display region DA seamlessly. The wall portion WL is an example of the protrusion in the present embodiment. The display panel PNL may further comprise the main spacer MS and the subspacer SS disclosed in the first embodiment and the second embodiment.

FIG. 18 is a schematic cross-sectional view of the display panel PNL along line F18-F18 in FIG. 17. As in the third embodiment, the wall portion WL protrudes from the counter substrate CT toward the array substrate AR, and the adhesive AD is arranged between the tip of the wall portion WL and the array substrate AR.

The wall portion WL is in contact with the liquid crystal layer LC. The sealing member SE is not in contact with the liquid crystal layer LC. However, a part of the frame-shaped sealing member SE shown in the plan view of FIG. 17 may be in contact with the liquid crystal layer LC.

A gap is provided between the sealing member SE and the wall portion WL. In the manufacturing process of bonding the array substrate AR and the counter substrate CT together, the sealing member SE spreads in the width direction. By providing the above-described gap, it is possible to suppress the wall portion WL from being damaged by a force from the sealing member SE when the width of the sealing member SE spreads.

A width Wd of the above-described gap is, for example, less than the width Wb of the sealing member SE but greater than the width Wa of the wall portion WL (Wa<Wd<Wb). When the tolerance of the formation position of the sealing member SE and the tolerance of the width of the sealing member SE are considered, the width Wd should preferably be greater than or equal to 100 μm (Wd>100 μm). It should be noted that a part of the frame-shaped sealing member SE shown in the plan view of FIG. 17 may be in contact with the wall portion WL.

When the liquid crystal layer LC is formed by the ODF method, the liquid crystal material is dropped inside the semi-cured sealing member SE formed on the array substrate AR or the counter substrate CT. Furthermore, the array substrate AR and the counter substrate CT are bonded together, and then the sealing member SE is cured. In this process, since the liquid crystal layer LC contacts the semi-cured sealing member SE, the resin component of the sealing member SE may be eluted into the liquid crystal layer LC, and ionic impurities may be generated.

On the other hand, in the present embodiment, the sealing member SE is not in contact with the liquid crystal layer LC. Therefore, the generation of the ionic impurities described above is suppressed, and consequently, display quality can be improved.

The present embodiment illustrates a configuration where the wall portion WL which is an example of the protrusion protrudes from the counter substrate CT toward the array substrate AR. However, the wall portion WL may protrude from the array substrate AR toward the counter substrate CT.

### Fifth Embodiment

The fifth embodiment will be described. As configurations which are not particularly mentioned, the same configurations as those of the above-described embodiments can be applied.

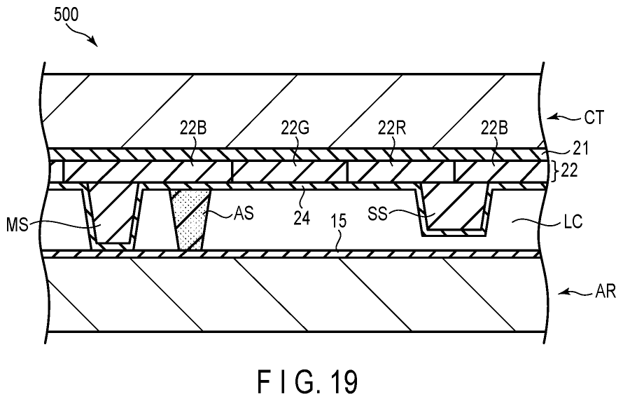

FIG. 19 is a schematic cross-sectional view of a liquid crystal display device 500 (hereinafter referred to as a display device 500) according to the fifth embodiment. The display device 500 comprises the main spacer MS, the subspacer SS and an adhesive spacer AS between the array substrate AR and the counter substrate CT. These spacers MS, SS and AS protrude from the counter substrate CT toward the array substrate AR. The main spacer MS is an example of the first protrusion in the present embodiment. The adhesive spacer AS is an example of the second protrusion in the present embodiment.

In the display region DA, the main spacers MS, the subspacers SS and the adhesive spacers AS are dispersedly arranged. All the spacers MS, SS and AS overlap the light-shielding layer 21 and the color filter layer 22.

The tips of the main spacer MS and the adhesive spacer AS are in contact with the array substrate AR (the first alignment film 15). The tip of the main spacer MS is not bonded to the array substrate AR but is slidable with respect to the array substrate AR. On the other hand, the tip of the adhesive spacer AS is bonded (adheres) to the array substrate AR (the first alignment film 15). A gap is formed between the subspacer SS and the array substrate AR.

The color filter layer 22 includes a red color filter 22R, a green color filter 22G and a blue color filter 22B. In the example of FIG. 19, the main spacer MS and the adhesive spacer AS overlap the color filter 22B, and the subspacer SS overlaps the boundary of the color filters 22R and 22B. However, these spacers are not limited to this example. Although omitted in FIG. 19, the lower surface of the color filter layer 22 is covered with the overcoat layer 23 as in the example of FIG. 3.

The second alignment film 24 covers the side surface and the tip of the main spacer MS. In addition, the second alignment film 24 covers the side surface and the tip of the subspacer SS. The second alignment film 24 may be extremely thin at the tips of these spacers MS and SS, or there may be places at these tips which are not covered with the second alignment film 24.

On the other hand, the second alignment film 24 passes between the adhesive spacer AS and the color filter layer 22. From another perspective, the adhesive spacer AS is located between the second alignment film 24 and the array substrate AR.

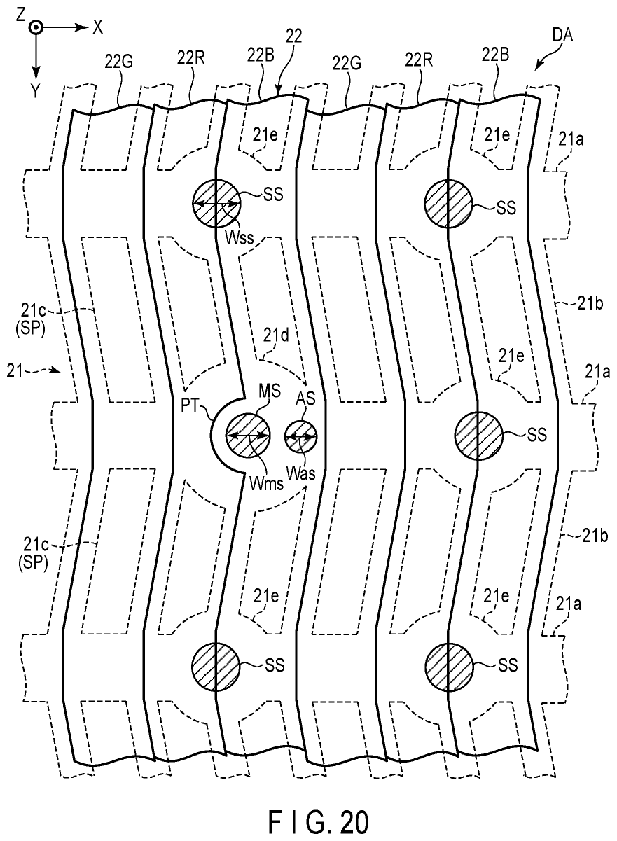

FIG. 20 is a schematic plan view showing an example of the shapes of the light-shielding layer 21, the color filter layer 22 and the spacers MS, SS and AS. The color filters 22R, 22G and 22B extend in a strip shape in the second direction Y according to the shape of the subpixel SP. In the illustrated example, the color filters 22G, 22R and 22B are repeatedly arranged in this order in the first direction X.

The light-shielding layer 21 has a first portion 21a overlapping the scanning line G shown in FIG. 2, and a second portion 21b overlapping the signal line S shown in FIG. 2. The width in the second direction Y of the first portion 21a is greater than the width in the first direction X of the second portion 21b. The first portions 21a and the second portions 21b form an opening 21c in each subpixel SP.

For example, the main spacer MS and the subspacer SS each are arranged at a position at which the first portion 21a and the second portion 21b intersect each other (at a position at which the scanning line G and the signal line S intersect each other). Around the main spacer MS, the light-shielding layer 21 has a circular expansion portion 21b. In addition, around the subspacer SS, the light-shielding layer 22 has a circular expansion portion 21e. The diameter of the expansion portion 21b is greater than the diameter of the expansion portion 21e. These expansion portions 21d and 21e suppress display failure due to the alignment disorder of the liquid crystal molecules caused by the spacers MS and SS.

The adhesive spacer AS is arranged close to the main spacer MS. That is, the distance between the adhesive spacer AS and the main spacer MS is less than the distance between the adhesive spacer AS and the subspacer SS. It should be noted that the adhesive spacer AS is not limited to this example but may be arranged at another position such as a position close to the subspacer SS.

The adhesive spacer AS overlaps the first portion 21a. As shown in the drawing, it is preferable that the adhesive spacer AS should be arranged within the circular range of the expansion portion 21d. Accordingly, the light-shielding layer does not need to be expanded for the adhesive spacer AS, and the opening 21c around the adhesive spacer AS can be enlarged.

Each subspacer SS overlaps the boundary of the color filters 22R and 22B. On the other hand, the main spacer MS and the adhesive spacer AS do not overlap such a boundary but overlap the color filter 22B. The main spacer MS has its tip contact the array substrate AR and maintains the cell gap constant. In addition, the adhesive spacer AS bonds the array substrate AR and the counter substrate CT together to suppress the misalignment of these two. Therefore, a certain degree of accuracy is required for the heights of the main spacer MS and the adhesive spacer AS. In this regard, it is possible to accurately form the main spacer MS and the adhesive spacer having a desired height by avoiding the overlapping of the main spacer MS and the adhesive spacer AS and the boundary of the adjacent color filters.

In the example of FIG. 20, the color filter 22B has a protrusion portion PT protruding toward the adjacent color filter 22R. In addition, the main spacer MS is arranged such that the main spacer MS overlaps this protrusion portion PT. According to this structure, it is possible to avoid the overlapping of the main spacer MS and the boundary of the color filters 22R and 22B while arranging the main spacer MS at a position at which the scanning line G and the signal line S intersect each other.

The adhesive spacer AS may be arranged for all of the main spacers MS arranged dispersedly across the display region DA, or may be arranged for some of the main spacers MS.

It is known that, when the distribution density of the spacers defining the cell gap is high, and when an impact is applied to the display panel PNL under low temperature, bubbles are generated in the liquid crystal layer LC. These bubbles are called low temperature impact bubbles. In the present embodiment, not only the main spacer MS but also the adhesive spacer AS are disposed. Therefore, in order to suppress low temperature impact bubbles, it is necessary to adjust the distribution densities and the sizes of the main spacer MS and the adhesive spacer AS.

In the example of FIG. 20, a width Wms of the main spacer MS is less than a width Wss of the subspacer SS (Wss>Wms). In addition, a width Was of the adhesive spacer AS is less than the width Wms of the main spacer MS (Wms>Was). When the width Wms and the width Was are reduced in this way, low temperature impact bubbles can be suppressed. In addition, when the width Was is reduced, the periphery of the adhesive spacer AS can be light shielded more easily by the light-shielding layer 21. As another method, it is possible to suppress low temperature impact bubbles by reducing the distribution densities of the main spacer MS and the adhesive spacer AS.

It should be noted that the widths Wms, Wss and Was may be the width of the root of the spacers MS, SS and AS, the width of the tip, or the width of the middle between the root and the tip. It is preferable that Wss>Wms>Was should be satisfied at each of the root, the tip and the middle.

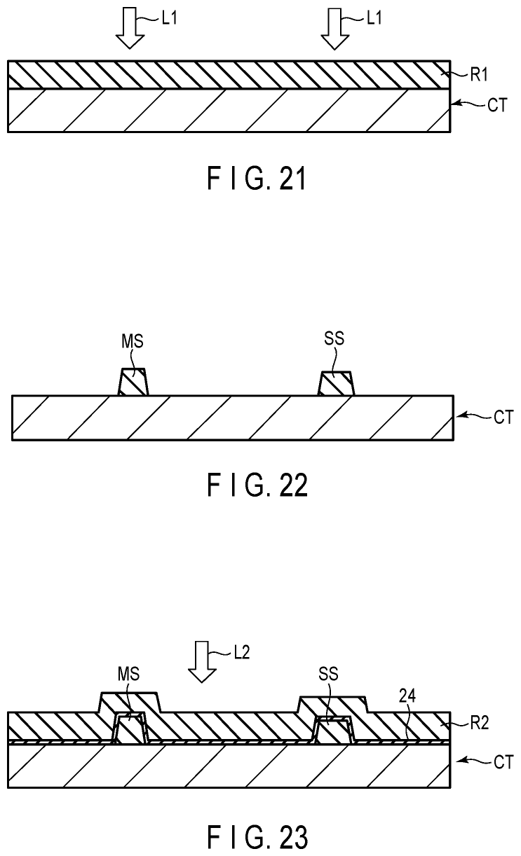

Next, an example of the manufacturing method of the display device 500 will be described with reference to FIGS. 21 to 24. First, the array substrate AR comprising the first base 10, the insulating layers 11 to 14, the first alignment film 15, the scanning line G, the signal line S, the switching element SW, the pixel electrode PE and the common electrode CE described above is manufactured. In addition, the counter substrate CT comprising the second base 20, the light-shielding layer 21, the color filter layer 22 and the overcoat layer 23 described above is manufactured.

Then, as shown in FIG. 21, a photoresist R1 which becomes the base of the mains pacer MS and the subspacer SS is formed on the counter substrate CT (on the overcoat layer 23). Furthermore, the photoresist R1 is baked (pre-baking), and then light L1 is radiated to positions at which the main spacer MS and the subspacer SS are formed in the photoresist R1 (exposure). At this time, since the heights of the main spacer MS and the subspacer SS are different from each other, a multi-tone mask is used.

After that, the excess photoresist R1 is removed using a chemical solution (development) so that the main spacer MS and the subspacer SS are formed as shown in FIG. 22. As an example, one main spacer MS and one subspacer SS are illustrated here. The main spacer MS and the subspacer SS are further baked so that strength thereof can be increased (post-baking).

After the main spacer MS and the subspacer SS are formed, the second alignment film 24 is formed as shown in FIG. 23. An alignment ability is imparted to the second alignment film 24 by alignment treatment such as rubbing treatment, photodecomposition treatment or photocuring treatment. In any alignment treatment, the second alignment film 24 is baked at a temperature of, for example, about 230° C.

The main spacer MS and the subspacer SS are covered with the second alignment film 24. As described above, the second alignment film 24 may flow down from the tips of the main spacer MS and the subspacer SS. In that case, the tips of the main spacer MS and the subspacer SS are exposed from the second alignment film 24 or covered with the thinner second alignment film 24 than other parts thereof.

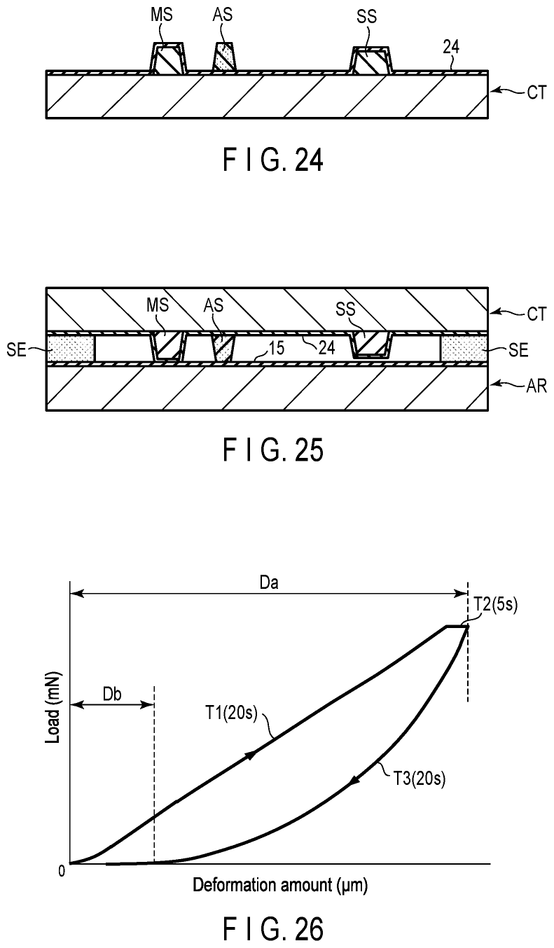

Furthermore, as shown in FIG. 23, a photoresist R2 which becomes the base of the adhesive spacer AS is formed. The photoresist R2 is baked (pre-baking), and then light L2 is radiated to a position at which the adhesive spacer AS is formed in the photoresist R2 (exposure). After that, the excess photoresist R2 is removed using a chemical solution (development) so that the adhesive spacer AS is formed as shown in FIG. 24.

The counter substrate CT manufactured in this way is bonded to the array substrate AR by the sealing member SE as shown in FIG. 25. The tip of the adhesive spacer AS contacts the array substrate AR (the first alignment film 15). At this stage, the adhesive spacer AS is not properly baked. Therefore, the adhesive spacer AS is in a semi-cured state where the cross-linking has not progressed sufficiently.

After that, the sealing member SE is cured by heating while the counter substrate CT and the array substrate AR are bonded together. By this heat, cross-linking also progresses in the adhesive spacer AS, and the tip of the adhesive spacer AS is bonded to the array substrate AR.

It should be noted that, in the state shown in FIG. 24, the height of the adhesive spacer AS may be greater than the height of the main spacer MS. In that case, during the subsequent bonding, the tip of the adhesive spacer AS easily adheres to the array substrate AR.

The main spacer MS, the subspacer SS and the adhesive spacer AS can be formed of a resin material such as acrylic-based resin or epoxy-based resin. However, since the main spacer MS has a role of maintaining the cell gap, it is preferable that the main spacer MS should have a sufficiently cross-linked and hard-to-crush property. On the other hand, since the adhesive spacer AS has a role of bonding the array substrate AR and the counter substrate CT together, it is preferable that the adhesive spacer AS should have a low cross-linked and flexible property.

FIG. 26 is a graph showing an example of the relationship between a load (mN) applied to a resin spacer and a deformation amount (μm) of the spacer. In the example of this drawing, a load in the height direction is gradually applied to the spacer in a period T1 (for example, 20 seconds), the load is set to constant in a period T2 (for example, 5 seconds), and the load is gradually reduced in a period T3 (for example, 20 seconds).

In the period T1, the deformation amount increases with the increase of the load. The deformation amount also increases in the period T2, and the deformation amount decreases with the decrease of the load in the period T3. Since the spacer deforms plastically, the deformation amount does not become 0 even when the load becomes 0.

Here, the deformation amount (total deformation amount) at the completion of the period T2 is defined as Da, and the deformation amount (plastic deformation amount) at the completion of the period T3 is defined as Db. Furthermore, the height of the spacer is defined as H. In this case, the total deformation rate (%) of the spacer in the cycle of FIG. 26 can be expressed as Da/H×100. In addition, the restoration rate (%) in the cycle can be expressed as (Da−Db)/Da×100. The deformation rate and the restoration rate mainly depend on the material of the spacer, the applied load and the diameter (or cross-sectional area). When the load and the diameter are the same between the main spacer MS and the adhesive spacer AS, it is preferable that the main spacer MS and the adhesive spacer AS should have an equal deformation rate.

In addition, since the main spacer MS needs to be hard to deform in order to maintain the cell gap, it is preferable that the main spacer MS should be baked properly and sufficiently in the above-described manufacturing process. On the other hand, in the above-described manufacturing process, the counter substrate CT and the array substrate AR are bonded together in a state where the adhesive spacer AS is not properly baked, and then the adhesive spacer AS is cured by the heat when the sealing member SE is cured. In this case, since cross-linking does not progress in the adhesive spacer AS as much as in the main spacer MS, when the load and the diameter are the same between these two, the restoration rate of the adhesive spacer AS becomes less than the restoration rate of the main spacer MS. The adhesive spacer AS having such a small restoration rate is unlikely to be peeled from the array substrate AR or the counter substrate CT even when an external force is applied to the display panel PNL.

Also when the array substrate AR and the counter substrate CT are bonded together by the adhesive spacer AS different from the main spacer MS as in the above-described present embodiment, the same effects as those obtained in the above-described embodiments can be obtained.

When a fluid adhesive is applied to the tip of the main spacer MS and the array substrate AR, the adhesive may spread more than necessary. In the present embodiment, the adhesive spacer AS is patterned on the counter substrate CT, and therefore the spreading of the adhesive does not occur.

In addition, in the present embodiment, the main spacer MS is covered with the second alignment film 24, and the second alignment film 24 is located between the adhesive spacer AS and the color filter layer 22. In this case, as shown in FIGS. 23 and 24, the adhesive spacer AS can be formed in a semi-cured state after the second alignment film 24 is baked. If the adhesive spacer AS is formed first and then the second alignment film 24 is formed, the second alignment film 24 needs to be baked at such a low temperature that the cross-linking reaction of the adhesive spacer AS will not be completed. In addition, the second alignment film 24 may adhere to the tip of the adhesive spacer AS, and the adhesiveness to the array substrate AR may be reduced. On the contrary, according to the configuration of the present embodiment, the second alignment film 24 does not need to be baked at low temperature, and since the second alignment film 24 is not present at the tip of the adhesive spacer AS, the adhesiveness to the array substrate AR is improved.

### Sixth Embodiment

The sixth embodiment will be described. As for configurations which are not particularly mentioned, the same configurations as those of the above-described embodiments can be applied.

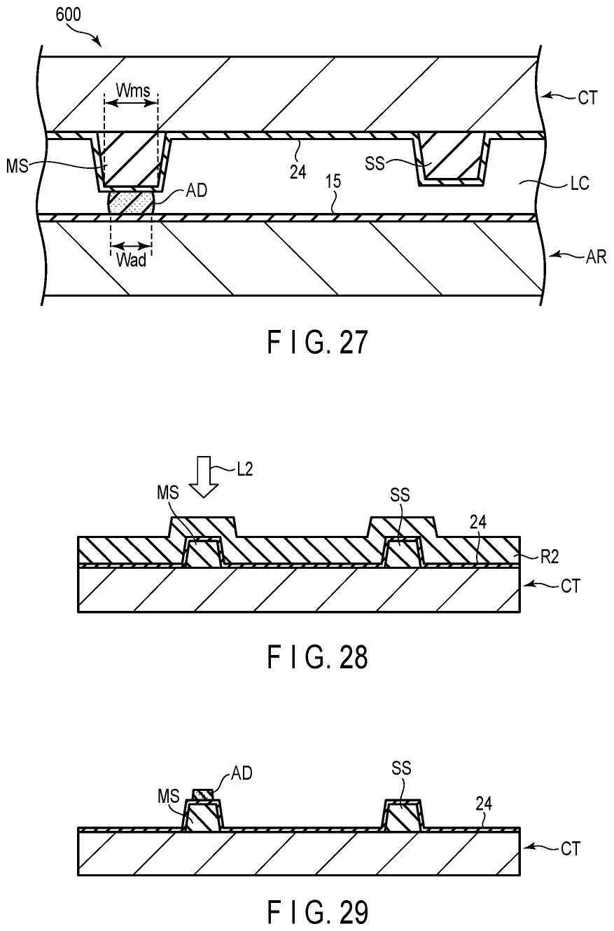

FIG. 27 is a schematic cross-sectional view of a liquid crystal display device 600 (hereinafter referred to as a display device 600) according to the sixth embodiment. The display device 600 comprises the main spacer MS, the subspacer SS, and the adhesive AD located between the main spacer MS and the array substrate AR as in the first embodiment.

In the present embodiment, a width Wad of the adhesive AD is less than the width Wms of the tip of the main spacer MS (Wad Wms). The “tip” of the main spacer MS means a part of the surface of the main spacer MS which has a height of greater than or equal to 90% of the maximum height of the main spacer MS. The adhesive AD is fitted in a region between the tip and the array substrate AR, and does not protrude from the region.

Next, an example of the manufacturing method of the display device 600 will be described with reference to FIGS. 28 to 30. Up to the point of forming the main spacer MS, the subspacer SS and the second alignment film 24 on the counter substrate CT and forming the photoresist R2 thereon, the process is the same as that of the fifth embodiment. However, the height of the main spacer MS and the height of the subspacer SS may be the same in the present embodiment.

After the photoresist R2 is formed, as shown in FIG. 28, light L2 is radiated above the main spacer MS (exposure). Furthermore, the excess photoresist R2 is removed using a chemical solution (development) so that the adhesive AD is formed as shown in FIG. 29.

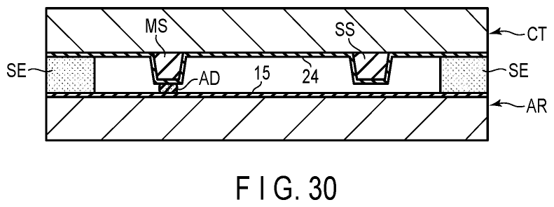

The counter substrate CT manufactured in this way is bonded to the array substrate AR by the sealing member SE as shown in FIG. 30. The adhesive AD contacts the array substrate AR (the first alignment film 15). At this stage, the adhesive AD is not properly baked. Therefore, the adhesive AD is in a semi-cured state where the cross-linking has not progressed sufficiently.

After that, the sealing member SE is cured by heating while the counter substrate CT and the array substrate AR are bonded together. By this heat, cross-linking also progresses in the adhesive AD, and the main spacer MS and the array substrate AR are bonded together by the adhesive AD.

As described above, in the present embodiment, the adhesive AD is formed in the same manner as the adhesive spacer AS in the fifth embodiment. That is, the adhesive AD is in a semi-cured solid state in the state shown in FIG. 29.

If a fluid adhesive is applied to the tip of the main spacer MS and the array substrate AR, the adhesive may spread more than necessary. Therefore, it is difficult to arrange the adhesive such that the adhesive is fitted between the tip of the main spacer MS and the array substrate AR. On the other hand, according to the adhesive AD in the present embodiment, such spreading does not occur. Therefore, the adhesive AD fitted between the tip of the main spacer MS and the array substrate AR can be formed.

As is the case with the adhesive spacer AS in the fifth embodiment, the restoration rate of the adhesive AD is less than that of the main spacer MS. Here, the total restoration rate of the main spacer MS and the adhesive AD is assumed. This total restoration rate corresponds to what is obtained when the plastic deformation amounts of the main spacer MS and the adhesive AD attached to the tip of the main spacer MS are subtracted from the total deformation amount when a predetermined load is applied to these two, the value is divided by the total deformation amount, and the value is expressed as a percentage.

If the main spacer MS and the subspacer SS have the same diameter (or cross-sectional area) and are subjected to the same load, due to the presence of the adhesive AD, the above-described total restoration rate becomes less than the restoration rate of the subspacer SS.

It should be noted that the adhesive AD in the present embodiment may be disposed for all of the main spacers MS arranged dispersedly across the display region DA or may be disposed for some of the main spacers MS.

All display devices, which are implementable with arbitrary changes in design by a person of ordinary skill in the art based on the display devices described above as the embodiments of the present invention, belong to the scope of the present invention as long as they encompass the spirit of the present invention.

Various modifications are easily conceivable within the category of the ideas of the present invention by a person of ordinary skill in the art, and these modifications are also considered to belong to the scope of the present invention. For example, additions, deletions or changes in design of the constituent elements or additions, omissions or changes in condition of the processes may be arbitrarily made to the above embodiments by a person of ordinary skill in the art, and these modifications also fall within the scope of the present invention as long as they encompass the spirit of the present invention.

In addition, the other advantages of the aspects described in the embodiments, which are obvious from the descriptions of the specification or which are arbitrarily conceivable by a person of ordinary skill in the art, are considered to be achievable by the present invention as a matter of course.

What is claimed is:

1. A display device comprising:
a first substrate having flexibility;
a second substrate having flexibility and opposed to the first substrate;
a first protrusion and a second protrusion protruding from the second substrate toward the first substrate;
a sealing member bonding the first substrate and the second substrate together in a peripheral region outside a display region including a pixel;
a first adhesive bonding the first protrusion and the first substrate together; and
a second adhesive bonding the second protrusion and the first substrate together, wherein
the second protrusion is located closer to an end of the second substrate than the first protrusion, and
a width of the first protrusion is greater than a width of the second protrusion.

2. The display device of claim 1, wherein a height of the second protrusion is greater than a height of the first protrusion.

3. The display device of claim 1, wherein the first substrate and the second substrate are bent.

4. A display device comprising:
a first substrate;
a second substrate opposed to the first substrate;
a sealing member bonding the first substrate and the second substrate together in a peripheral region outside a display region including a pixel;
a protrusion protruding from the second substrate toward the first substrate; and
an adhesive bonding the protrusion and the first substrate together, wherein
the protrusion extends along the sealing member in the peripheral region.

5. The display device of claim 4, wherein the protrusion is arranged between a peripheral edge of the second substrate and the sealing member.

6. The display device of claim 5, wherein
the sealing member has an injection port for a liquid crystal material, and
the protrusion surrounds the sealing member except the injection port.

7. The display device of claim 5, wherein a gap is provided between a side surface of the second substrate and the protrusion in planar view.

8. The display device of claim 4, wherein the protrusion is arranged between the sealing member and the display region.

9. The display device of claim 8, wherein a gap is provided between the protrusion and the sealing member.

10. The display device of claim 8, further comprising a liquid crystal layer arranged between the first substrate and the second substrate, wherein
the protrusion surrounds the display region, and is in contact with the liquid crystal layer.

11. The display device of claim 4, further comprising:
a liquid crystal layer arranged between the first substrate and the second substrate; and
a light source radiating light to a side surface of the first substrate or the second substrate, wherein
the liquid crystal layer is switchable between a state of scattering light from the light source and a state of transmitting light from the light source according to applied voltage.

12. A display device comprising:
a first substrate;
a second substrate opposed to the first substrate;
a sealing member bonding the first substrate and the second substrate together in a peripheral region outside a display region including a pixel; and
a first protrusion and a second protrusion protruding from the second substrate toward the first substrate, wherein
the first protrusion is in contact with the first substrate without being bonded to the first substrate, and
the second protrusion is bonded to the first substrate.

13. The display device of claim 12, wherein a restoration rate when a load is applied to the second protrusion is less than a restoration rate when the load is applied to the first protrusion.

14. The display device of claim 12, wherein a width of the second protrusion is less than a width of the first protrusion.

15. The display device of claim 12, further comprising a third protrusion protruding from the second substrate toward the first substrate, and opposed to the first substrate via a gap, wherein
a width of the first protrusion and a width of the second protrusion are less than a width of the third protrusion.

16. The display device of claim 12, wherein
the second substrate comprises an alignment film opposed to the first substrate,
the alignment film covers at least a part of the first protrusion, and
the second protrusion is located between the alignment film and the first substrate.
